(19) United States
(12) Patent Application Publication
(10) Pub. No.: US 2025/0309311 A1
(43) Pub. Date: Oct. 2, 2025

(54) FUEL CELL STACKS WITH CONFIGURABLE ORIENTATIONS

(71) Applicant: Robert Bosch GmbH, Stuttgart (DE)

(72) Inventors: Sarah STEWART, San Carlos, CA (US); Bjoern STUEHMEIER, Santa Clara, CA (US); Jonathan BRAATEN, Sunnyvale, CA (US)

(21) Appl. No.: 18/620,286

(22) Filed: Mar. 28, 2024

(51) Int. Cl. H01M 8/2465; H01M 8/04089

(52) U.S. Cl. CPC H01M 8/2465; H01M 8/04089

(57) ABSTRACT

A method of operating a fuel cell stack. The method includes, in a first state, communicating a first reactant into a first orifice in a first fuel cell and a first product out of a second orifice in the first fuel cell to form a first flow path. The method further includes transitioning the first fuel cell from the first state into a second state. The method also includes, in a second state, communicating the first reactant into the second orifice in the first fuel cell and the second product out of the first orifice in the first fuel cell to form a second flow path opposite the first flow path.

### TECHNICAL FIELD

The present disclosure relates to fuel cell stacks with configurable orientations. A configurable orientation of the fuel cell stack may be used to increase the lifetime of the fuel cell stack.

### BACKGROUND

Fuel cells convert chemical energy from a fuel into electricity using a chemical reaction. The fuel cell includes a cathode electrode, an anode electrode, and an electrolyte. One form of fuel cell is a hydrogen fuel cell. The hydrogen fuel cell is configured to react hydrogen with oxygen to produce electricity and a water byproduct, thereby producing energy in a clean and environmentally friendly manner. One form of hydrogen fuel cell is a polymer electrolyte membrane fuel cell, otherwise referred to as a PEMFC. The PEMFC operates at relatively low temperatures and uses a polymer electrolyte membrane (PEM) as the electrolyte.

A collection of individual fuel cells may be connected in series or parallel to form a fuel cell stack. The individual fuel cells within the fuel cell stack contributes to the overall electrical output of the fuel cell stack, thereby increasing the overall power output. The fuel cell stack current can be adapted to achieve the power requirements for various applications (e.g., vehicles, portable devices, power plants, etc.)

### SUMMARY

One or more embodiments are directed to a fuel cell stack (e.g., a polymer electrolyte membrane fuel cell stack) that is configured (e.g., rotated) during its operation to uniformly age the membrane electrode assemblies (MEAs) of the fuel cell stack to extend the lifetime of the fuel cell stack. The inlets and outlets of the fuel cell stack may be switched at a specified age of the fuel cell stack to extend the lifetime of the fuel cell stack.

In one embodiment, a fuel cell stack is disclosed. The fuel cell stack may include a first fuel cell having a first electrode communicating with a first orifice and a second orifice. The first fuel cell has a first state in which the first orifice communicates a first reactant into the first electrode and the second orifice communicates a first product out of the first electrode to form a first flow path. The first fuel cell has a second state in which the first orifice communicates the first product out of the first electrode and the second orifice communicates the first reactant into the first electrode to form a second flow path opposite the first flow path. The fuel cell stack further includes a second fuel cell having a second electrode having a third orifice and a fourth orifice. The fuel cell stack has a transitional configuration in which the first fuel cell transitions from the first state to the second state.

In a second embodiment, a fuel cell stack is disclosed. The fuel cell stack includes a first surface, a first fuel cell adjacent to the first surface and having a first state and a second state, a second surface opposite the first surface, and a second fuel cell adjacent to the second surface. The fuel cell stack has a transitional configuration that transitions the first fuel cell and the second fuel cell from the first state to the second state where the first surface is a top surface and the second surface is a bottom surface in the first state and the second surface is the top surface and the second surface is the bottom surface in the second state.

In a third embodiment, a method of operating a fuel cell stack is disclosed. In a first state, a first reactant is communicated into a first orifice in a first fuel cell and a first product is communicated out of a second orifice in the first fuel cell to form a first floe path. The method further includes transitioning the first fuel cell from the first state into a second state. The method further includes, in the second state, communicating the first reactant into the second orifice in the first fuel cell and the first product out of the first orifice in the first fuel cell to form a second flow path opposite the first flow path. The transitioning step may occur after a regular interval of operation of the fuel cell stack. The transitioning step may include switching a first conduit from the first orifice to the second orifice and a second orifice from the second orifice to the first orifice. The transitioning step may include flipping or rotating the fuel cell stack.

### BRIEF DESCRIPTION OF THE DRAWINGS

FIG. 1 depicts a micro X-ray diffraction (micro-XRD) map showing heterogeneity in catalyst (e.g., Pt or Pt alloy) particle size between an anode inlet and an anode outlet of an anode side of a fuel cell as shown in the depicted legend.

FIG. 2 depicts a schematic, side view of an individual fuel cell according to one embodiment.

FIG. 3 depicts a perspective view of a fuel cell stack according to one embodiment.

FIG. 4 depicts a fuel cell stack according to another embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of embodiments of the invention. Practice within the numerical limits stated is generally preferred according to one or more embodiments. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. These terms may be used to modify any numeric value disclosed or claimed herein. Generally, the term “about” denoting a certain value is intended to denote a range within +5% of the value. As one example, the phrase “about 100” denotes a range of 100±5, i.e., the range from 95 to 105. Generally, when the term “about” is used, it can be expected that similar results or effects according to the invention can be obtained within a range of +5% of the indicated value. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1 to 10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “and/or” means that either all or only one of the elements of said group may be present. For example, “A and/or B” means “only A, or only B, or both A and B”. In the case of “only A”, the term also covers the possibility that B is absent, i.e., “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description and does not necessarily preclude chemical interactions among constituents of the mixture once mixed. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

A polymer electrolyte membrane fuel cell (PEMFC) may experience deteriorating power as it ages. This power deterioration may limit the useful life of the PEMFC as a power source. The power in the PEMFC may deteriorate due to a loss of catalyst sites (e.g., platinum group catalyst (PGM) dissolution). An additional power deterioration mechanism is mass transport loss (e.g., from carbon support corrosion). The power degradation may occur non-uniformly throughout the membrane electrode assembly (MEA) of the PEMFC. For instance, the MEA may not be fueled evenly by the channels within the fuel cell. This degradation may be especially acute due to start up and shut down events where degradation occurs primarily at the outlet or inlet, respectively, of the PEMFC. For example, severe degradation may occur during start up and/or shut down events in a region that remains or becomes transiently starved in hydrogen. Degradation may also occur non-uniformly due to the distribution of water throughout the MEA and the fuel cell stack (e.g., the MEA may be more humidified toward the outlet). Localized membrane thinning may also contribute to non-uniform degradation of the MEA. For instance, larger catalyst particles with less active area may be found near the outlet due to increased water content at the outlet.

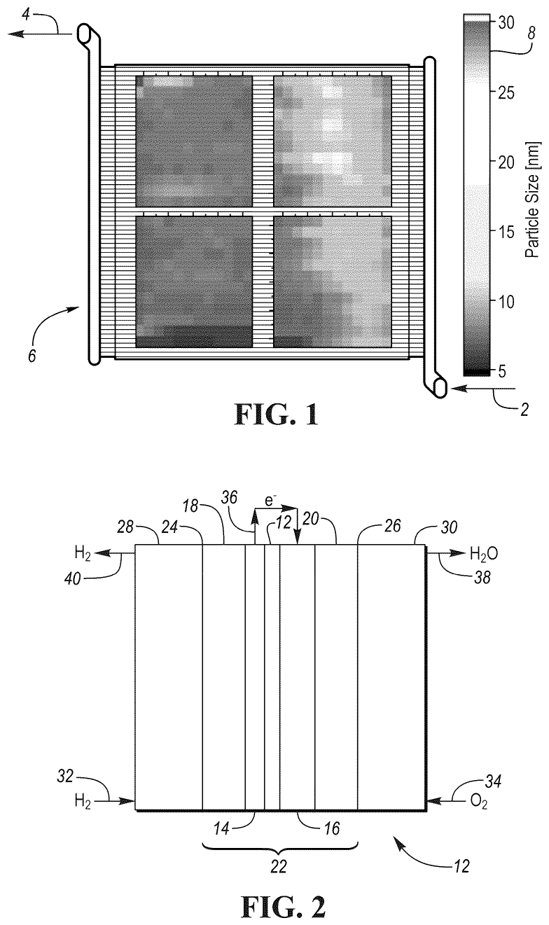

Water management and reactant distribution may greatly affect the performance and life span of a fuel cell stack (e.g., a collection of individual fuel cells). Generated water may accumulate and block reactants from flowing into a fuel cell channel, thereby hindering diffusion into the catalyst layer for the electrochemical reaction that occurs within a fuel cell. Non-uniform distribution of reactants may induce fuel gas starvation events in a fuel cell, which may lead to an increase in fuel cell potential and promote carbon corrosion and loss of a catalyst's active area. This non-uniform distribution of reactants may cause the performance of a fuel cell to irreversibly decline and the life span of the fuel cell to degrade. A degradation rate induced by repeated start-ups may be highly heterogeneous. A first level of aging heterogeneity may arise between an anode inlet and an anode outlet. FIG. 1 depicts a micro X-ray diffraction (microXRD) map showing heterogeneity in catalyst (Pt) particle size between anode inlet 2 and anode outlet 4 of anode side 6 as shown in legend 8 after start-up/shut-down cycling. FIG. 1 shows that larger catalyst particles are shown near anode inlet 2.

In light of the foregoing, what is needed is a fuel cell and method of operating a fuel cell to reduce non-uniform degradation of the fuel cell, including the MEA of the fuel cell. In one or more embodiments, a fuel cell is structured to reduce non-uniform degradation in the fuel cell (e.g., the MEA). In other embodiments, a method of operating a fuel cell or a fuel cell stack is disclosed that reduces non-uniform degradation in the MEA(s) of the fuel cell or the fuel cell stack. One embodiment includes rotating a fuel cell or a fuel cell stack to uniformly age the MEA. In another embodiment, the inlet and outlet of the fuel cell or the fuel cell stack are switched at a specific age of the fuel cell to increase the uniformity of aging of the MEA. The age in which the switch occurs may depend on the application (e.g., heavy duty vehicles may have a longer lifetime than passenger vehicles but significantly shorter lifetime than marine applications) and/or how the switch is performed (e.g., the fuel cell stack is rotates at each maintenance interval or only once at a half-life point). In one embodiment, the specific age for switching is 500 to 20,000 hours of operation. In another embodiment, the range may be 500 to 3,000 hours for a repeated switching during regular maintenance. In yet another embodiment, the range may be 7,000 to 20,000 hours for a one-time switch at the half-life point. In other embodiments, the fuel cell or the fuel cell stack is reoriented, rotated, or flipped to increase the uniformity of aging of the MEA(s). One or more embodiments may be used to extend the usable lifetime of the fuel cell or the fuel cell stack by reducing the non-uniform degradation of the fuel cell or the fuel cell stack.

FIG. 2 depicts a schematic, side view of fuel cell 10 according to one embodiment. Fuel cell 10 is an example of a polymer electrolyte membrane fuel cell (PEMFC). Fuel cell 10 includes polymer electrolyte membrane (PEM) 12, anode 14, cathode 16 and first and second gas diffusion layers (GDLs) 18 and 20. A catalyst material, such as platinum, is used in anode 14 and cathode 16. PEM 12 is situated between anode 14 and cathode 16. Anode 14 is situated between first GDL 18 and PEM 12 and cathode 16 is situated between second GDL 20 and PEM 12. PEM 12, anode 14, cathode 16 and first and second GDLs 18 and 20 comprise membrane electrode assembly (MEA) 22.

First and second sides 24 and 26 of MEA 22 are bounded by flow channels 28 and 30, respectively. Flow channel 28 supplies H₂ to MEA 22 through inlet 32. Flow channel 30 supplies O₂ in the form of air to MEA 22 through inlet 34. The H₂ is fed to anode 14 through flow channel 28 and undergoes electrochemical oxidation in the presence of a catalyst to split the H₂ into protons (H⁺) and electrons (e⁻). The protons (H⁺) are transported through PEM 12 to cathode 16, while the electrons (e⁻) flow through external circuit 36 to cathode 16. The flow of electrons (e⁻) through external circuit 36 generates an electrical current that can power electrical devices or charge a battery. The O₂ is fed to cathode 16 through flow channel 30 and reacts with the protons (H⁺) that traveled through PEM 12 and the electrons (e⁻) that flowed through external circuit 36 form a water byproduct, which exits outlet 38. Excess hydrogen fuel exits flow channel 28 at outlet 40.

Flow channels 28 and 30 are pathways configured to flow reactants (e.g., H₂ and O₂) and products (e.g., water). In one or more embodiments, the flow channels are configured to facilitate the movement of the reactants and/or products to one or more fuel cell components (e.g., PEM 12, anode 14, and cathode 16). Flow channels 28 and 30 may consist of parallel flow channels to facilitate uniform distribution of the reactants across the surface of the electrodes and minimize pressure drop across the flow fields. Flow channels 28 and 30 may form a serpentine path to aid in the uniform distribution of the reactants across the surface of the electrodes. Flow channels 28 and 30 may be bipolar plates formed from a lightweight, conductive material such as graphite, carbon composites, or a metal alloy. Bipolar plates are configured to have good electrical conductivity, high corrosion resistance, and mechanical durability to withstand the operating conditions within a fuel cell stack.

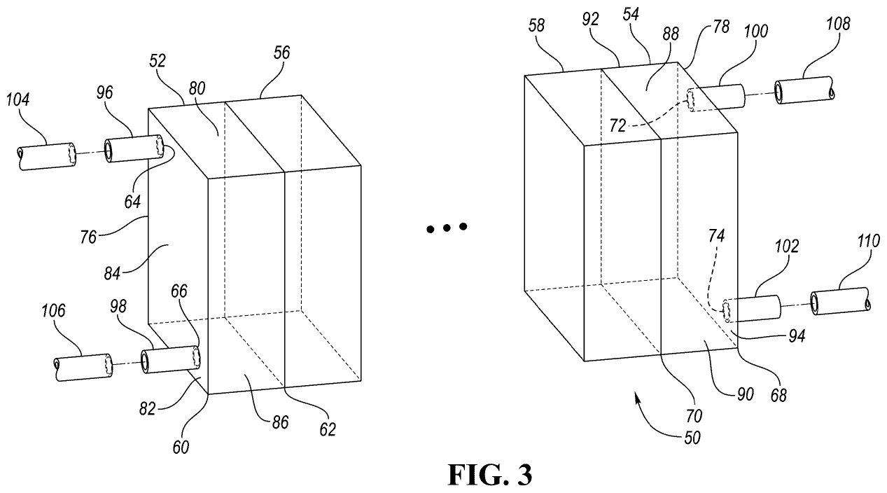

FIG. 3 depicts a perspective view of fuel cell stack 50 according to one embodiment. Fuel cell stack 50 includes first fuel cell 52 and second fuel cell 54 adjacent to and communicating with first fuel cell 52. Fuel cell stack 50 also includes third fuel cell 56 adjacent to and communicating with first fuel cell 52, and fourth fuel cell 58 adjacent to and communicating with second fuel cell 56. As represented by the ellipses depicted in FIG. 2, additional individual fuel cells span between third fuel cell 56 and fourth fuel cell 58. These additional individual fuel cells are in communication with each other and the other fuel cells to form fuel cell stack 50.

First fuel cell 52 includes a pair of electrodes. As depicted in FIG. 2, first fuel cell 52 has anode side 60 including an anode and cathode side 62 including a cathode. First fuel cell 52 includes first orifice 64 and second orifice 66. First orifice 64 and second orifice 66 communicate with the anode of anode side 60. As depicted in FIG. 2, second fuel cell 54 has cathode side 68 including a cathode and anode side 70 including an anode. Second fuel cell 54 includes third orifice 72 and fourth orifice 74. Third orifice 72 and fourth orifice 74 communicate with the cathode of cathode side 68.

First fuel cell 52 may have a first state in which first orifice 64 communicates a reactant (e.g., H₂) into the anode of anode side 60 and second orifice 66 communicates a product (e.g., excess, unconsumed H₂) out of the anode of anode side 60 to form a first flow path through flow channels within anode side 60 of first fuel cell 52. First fuel cell 52 may have a second state in which first orifice 64 communicates the product out of the anode of anode side 60 and second orifice 66 communicates the reactant into the anode of anode side 60 to form a second flow path through the flow channels. The second flow path is opposite (e.g., reverse) the first flow path.

Second fuel cell 54 may have the first state in which third orifice 72 communicates a reactant (e.g., air) into the cathode of cathode side 68 and fourth orifice 74 communicates a product (e.g., water) out of the cathode of cathode side 68 to form a third flow path through flow channels within cathode side 68 of second fuel cell 54. Second fuel cell 54 may have the second state in which third orifice 72 communicates the product out of the cathode of cathode side 68 and fourth orifice 74 communicates the reactant into the cathode of cathode side 68 to form a fourth flow path through the flow channels. The fourth flow path is opposite (e.g., reverse) the third flow path.

Fuel cell stack 50 may also have a transitional configuration in which first fuel cell 52 transitions from the first state to the second state and/or second fuel cell 54 transitions from the third state to the fourth state (and/or all other individual cells within the fuel cell stack). Fuel cell stack 50 may be configured to rotate about an axis (e.g., a longitudinal axis) of fuel cell stack 50 in the transitional configuration. Fuel cell stack 50 may be configured to flip (e.g., flip end over end) in the transitional configuration.

As shown in FIG. 3, first orifice 64 and second orifice 66 are formed on first end surface 76 of first fuel cell 52 and third orifice 72 and fourth orifice 74 are formed on second end surface 78 of second fuel cell 54. Alternatively, first orifice 64 and second orifice 66 may be formed on opposing peripheral surfaces of first fuel cell 52 and third orifice 72 and fourth orifice 74 are formed on opposing peripheral surfaces of second fuel cell 54. The opposing peripheral surfaces of first fuel cell 52 may be first peripheral surface 80 and second peripheral surface 82 or third peripheral surface 84 and fourth peripheral surface 86. The opposing peripheral surfaces of second fuel cell 54 may be first peripheral surface 88 and second peripheral surface 90 or third peripheral surface 92 and fourth peripheral surface 94.

In one or more embodiments, first orifice 64 and second orifice 66 are diagonally symmetrical a plane or an axis of first fuel cell 52. In one or more embodiments, third orifice 72 and fourth orifice 74 are diagonally symmetrical a plane or an axis of second fuel cell 54. This diagonal symmetry may facilitate transition with the transitional configuration to switch from the first state to the second state. In other embodiments, first orifice 64 and second orifice 66 are not symmetrical a diagonal plane or axis of first fuel cell 52, and/or third orifice 72 and fourth orifice 74 are not symmetrical a diagonal plane or axis of second fuel cell 54.

As shown in FIG. 3, first conduit 96 communicates with first orifice 64 and second conduit 98 communicates with second orifice 66. The depiction shown in FIG. 3 may represent the first state. In the second state, first conduit 96 communicates with second orifice 66 and second conduit 98 communicates with first orifice 64. The reactant and product streams are switched from the first state to the second state through one of the transition configurations disclosed herein. In one embodiment, first conduit 96 and second conduit 98 may be rotated, flipped, or switched from the first state to the second state, while maintaining fuel cell stack 50 in a stationary position, or vice versa (e.g., maintaining the conduits in a stationary position and rotating or flipping fuel cell stack 50).

As shown in FIG. 3, third conduit 100 communicates with third orifice 72 and fourth conduit 102 communicates with fourth orifice 74. The depiction shown in FIG. 3 may represent the first state. In the second state, third conduit 100 communicates with fourth orifice 74 and fourth conduit 102 communicates with third orifice 72. The reactant and product streams are switched from the first state to the second state through one of the transition configurations disclosed herein. In one embodiment, third conduit 100 and fourth conduit 102 may be rotated, flipped, or switched from the first state to the second state, while maintaining fuel cell stack 50 in a stationary position, or vice versa (e.g., maintaining the conduits in a stationary position and rotating or flipping fuel cell stack 50).

As shown in FIG. 3, first supply conduit 104 communicates with first orifice 64 and first return conduit 106 communicates with second orifice 66. The depiction shown in FIG. 3 may represent the first state. In the second state, first supply conduit 104 communicates with second orifice 66 and first return conduit 106 communicates with first orifice 64. The reactant and product streams are switched from the first state to the second state through one of the transition configurations disclosed herein. In one embodiment, first reactant conduit 104 and first return conduit 106 may be rotated, flipped, or switched from the first state to the second state, while maintaining fuel cell stack 50 in a stationary position, or vice versa.

As shown in FIG. 3, second supply conduit 108 communicates with third orifice 72 and second return conduit 110 communicates with fourth conduit 74. The depiction shown in FIG. 3 may represent the first state. In the second state, second supply conduit 108 communicates with fourth orifice 74 and second return conduit 110 communicates with third orifice 72. The reactant and product streams are switched from the first state to the second state through one of the transition configurations disclosed herein. In one embodiment, second supply conduit 108 and second return conduit 110 may be rotated, flipped, or switched from the first state to the second state, while maintaining fuel cell stack 50 in a stationary position, or vice versa. In one or more embodiments, the fuel cell stack may be stationary, but the connecting ports or tubes may be moved or changes to reverse the flow path.

In one or more embodiments, the fuel cell stack may be transitioned more than once between the first and second states. Each transition may occur regular interval during a maintenance procedure. The maintenance procedure may include extracting, rotating, reinserting, and/or connecting a fuel cell stack to allow for gas flows in the opposite direction to the original orientation. In one or more embodiments, each of the transitions reverses the direction of flow of the gases so that an inlet becomes an outlet, enabling more uniform degradation throughout at least a portion of the MEA and/or mitigating overstressing of the MEA to enhance lifetime. The fuel cell stack and/or power module may be configured so that the inlet and the outlet are switched between a first state and a second state. In one or more embodiments, a group of valves are used to control the direction of gas flow through the flow channels of one or more electrodes. The group of valves may be configured to transition operation from the first state to the second state without reorienting the fuel cell stack.

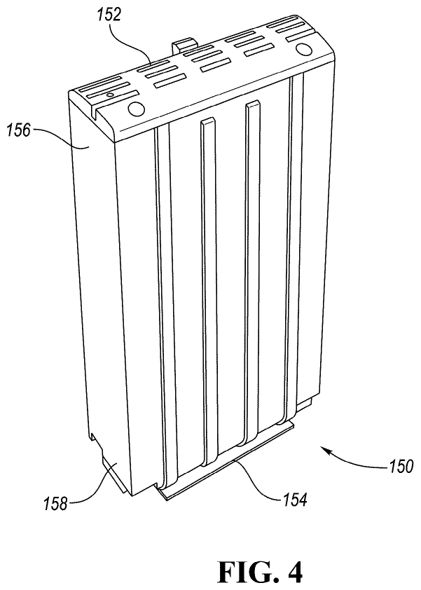

FIG. 4 depicts fuel cell stack 150 according to another embodiment. Fuel cell stack 150 has first surface 152 and second surface 154 with individual fuel cells extending in vertical orientation therebetween. Individual fuel cells include first fuel cell 156 adjacent to first surface 152 and second fuel cell 158 adjacent to second surface 154. Fuel cell stack 150 has a transitional configuration in which first fuel cell 156 and second fuel cell 158 transitions from a first state (shown in FIG. 4) into a second state. In the first state (as shown in FIG. 4), first surface 152 is a top surface and second surface 154 is a bottom surface. In the second state, second surface 154 is the top surface and first surface 152 is the bottom surface. First surface 152 has first orifice and second orifice communicating with an electrode in first fuel cell 156 and second surface 154 has third orifice and fourth orifice communicating with an electrode in second fuel cell 158. These orifices are configured to permit rotation (e.g., 180 degrees) of fuel cell stack 150 whereby the “bottom” cell (e.g., closest to the ground) becomes “top” cell (e.g., farthest from the ground) and vice versa. The transitional configuration is configured to mitigate gravitational induced inhomogeneities in the aging of the fuel cell stack (e.g., due to water accumulation in the lowest section of the stack).

The configurable orientations of the fuel cell stack of one or more embodiments may be applied to second life applications of the fuel cell stack. Non-limiting second life applications include backup power systems, stationary power generation, hydrogen production, and off-grid power solutions. Reconfiguring the orientation of the fuel cell stack as set forth in one or more embodiments may prolong the primary application (e.g., within a vehicle) and provide a second life application or prolong a second life application by helping extend the useful lifespan of the fuel cell stack, thereby reducing waste and contributing to sustainability.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A fuel cell stack comprising:
a first fuel cell having a first electrode communicating with a first orifice and a second orifice, the first fuel cell has a first state in which the first orifice communicates a first reactant into the first electrode and the second orifice communicates a first product out of the first electrode to form a first flow path, the first fuel cell has a second state in which the first orifice communicates the first product out of the first electrode and the second orifice communicates the first reactant into the first electrode to form a second flow path opposite the first flow path; and
a second fuel cell having a second electrode having a third orifice and a fourth orifice,
the fuel cell stack has a transitional configuration, the transitional configuration transitions the first fuel cell from the first state to the second state.

2. The fuel cell stack of claim 1, wherein the second fuel cell has a third state in which the third orifice communicates a second reactant into the second electrode and the fourth orifice communicates a second product out of the second electrode to form a third flow path, the second fuel cell has a fourth state in which the third orifice communicates the second product out of the second electrode and the fourth orifice communicates the second reactant into the second electrode to form a fourth flow path opposite the third flow path, the transition configuration transitions the second fuel cell from the third state to the fourth state.

3. The fuel cell stack of claim 1, wherein the first orifice communicates with a first conduit in the first state, the second orifice communicates with a second conduit in the first state, the first orifice communicates with the second conduit in the second state, the second orifice communicates with the first conduit in the second state.

4. The fuel cell stack of claim 1, wherein the first orifice communicates with a first supply conduit in the first state, the second orifice communicates with a first return conduit in the first state, the second orifice communicates with the first return conduit in the second state, the first orifice communicates with the first supply conduit in the second state.

5. The fuel cell stack of claim 1 further comprising a plurality of first valves configured to transition the first fuel cell from the first state to the second state.

6. The fuel cell stack of claim 1, wherein the first orifice and the second orifice are defined on a first surface of the first fuel cell.

7. The fuel cell stack of claim 5, wherein the first orifice and the second orifice are diagonally symmetrical a plane or an axis of the first fuel cell.

8. The fuel cell stack of claim 1, wherein the fuel cell stack is configured to rotate about an axis of the fuel cell stack in the transitional configuration.

9. The fuel cell stack of claim 1, wherein the fuel cell stack is configured to flip in the transitional configuration.

10. The fuel cell stack of claim 1, wherein the first electrode is an anode.

11. The fuel cell stack of claim 2, wherein the second electrode is a cathode.

12. A fuel cell stack comprising:
a first surface;
a first fuel cell adjacent to the first surface and having a first state and a second state;
a second surface opposite the first surface; and
a second fuel cell adjacent to the second surface,
the fuel cell stack has a transitional configuration, the transitional configuration transitions the first fuel cell and the second fuel cell from the first state to the second state, the first surface is a top surface and the second surface is a bottom surface in the first state, the second surface is the top surface and the second surface is the bottom surface in the second state.

13. The fuel cell stack of claim 12, wherein the first surface has a first orifice and a second orifice, the first fuel cell communicates with the first orifice and the second orifice.

14. The fuel cell stack of claim 13, wherein the second surface has a third orifice and a fourth orifice, the second fuel cell communicates with the third orifice and the fourth orifice.

15. The fuel cell stack of claim 12, wherein the fuel cell stack is configured to rotate about an axis of the fuel cell stack in the transitional configuration.

16. A method of operating a fuel cell stack comprising:
in a first state, communicating a first reactant into a first orifice in a first fuel cell and a first product out of a second orifice in the first fuel cell to form a first flow path;
transitioning the first fuel cell from the first state into a second state; and
in the second state, communicating the first reactant into the second orifice in the first fuel cell and the first product out of the first orifice in the first fuel cell to form a second flow path opposite the first flow path.

17. The method of claim 16, wherein the transitioning step occurs after a regular operating interval of the fuel cell stack.

18. The method of claim 16, wherein the transitioning step includes switching a first conduit from the first orifice to the second orifice and a second conduit from the second orifice to the first orifice.

19. The method of claim 16, wherein the transitioning step includes rotating or flipping the fuel cell stack.

20. The method of claim 16, wherein the transitioning step includes disconnecting and connecting a reactant connection and a product connection to the orifice while maintaining an orientation of the fuel cell stack.
